(19) United States
(12) Patent Application Publication
(10) Pub. No.: US 2016/0063024 A1
(43) Pub. Date: Mar. 3, 2016

(54) NETWORK STORAGE DEDUPLICATING METHOD AND SERVER USING THE SAME

(71) Applicant: Wistron Corporation, New Taipei City (TW)

(72) Inventor: Di Zheng, New Taipei City (TW)

(21) Appl. No.: 14/542,665

(22) Filed: Nov. 17, 2014

(30) Foreign Application Priority Data
Aug. 29, 2014 (CN) 201410436771.5

(51) Int. Cl. G06F 17/30; H04L 29/08

(52) U.S. Cl. CPC G06F 17/30156; H04L 67/1097; H04L 67/1006; G06F 17/30097; G06F 17/30203

(57) ABSTRACT

A network storage deduplicating method and a server using the same method are proposed. The method includes the following steps: receiving a first data through an Internet small computer system interface protocol; calculating identification information of the first data; determining whether a second data having the identification information is already stored in the server; if yes, generating and storing a pointer pointing to the second data and neglecting the first data.

### CROSS-REFERENCE TO RELATED APPLICATION

This application claims the priority benefit of China application serial no. 201410436771.5, filed on Aug. 29, 2014. The entirety of the above-mentioned patent application is hereby incorporated by reference herein and made a part of this specification.

### BACKGROUND OF THE INVENTION

1. Field of the Invention

The invention relates to a network storage method and a server using the same, and particularly relates to a network storage deduplicating method and a server using the same.

2. Description of Related Art

With the development of Internet and technology, various network storage technologies have been provided for the user to conveniently store or back up data in a virtual network storage space (e.g., cloud storage). However, since the back data tend to be highly repetitive, if a data storage mechanism is not properly designed, the storage space may be wasted.

### SUMMARY OF THE INVENTION

Accordingly, the invention provides a network storage deduplicating method and a server using the same capable of adaptively not storing repetitive data and thus improving a usage efficiency of a virtual network storage space.

The invention provides a network storage deduplicating method adapted for a server. The method includes steps as follows. First of all, a first data is received through an Internet small computer system interface protocol, and identification information of the first data is calculated. Then, whether a second data having the identification information is already stored in the server is determined. If the second data having the identification is already stored in the server, a pointer pointing to the second data is generated and stored and the first data is neglected.

According to an embodiment of the invention, the first data is a part of data of a transmitted file.

According to an embodiment of the invention, the step of calculating the identification information of the first data includes calculating the identification information of the first data when a data size of the first data meets a predetermined data size.

According to an embodiment of the invention, when second data is not stored in the server, the method further includes storing the first data and recording the identification information of the first data.

According to an embodiment of the invention, the step of calculating the identification information of the first data includes calculating a hash value of the first data as the identification information of the first data.

The invention provides a server including a storage unit, a communication unit, and a processing unit. The storage unit stores a plurality of modules. The processing unit is coupled to the storage unit and the communication unit and accesses and executes the plurality of modules. The plurality of modules include a receiving module, a calculating module, a determining module, and a generating module. The receiving module controls the communication unit to receive a first data through an Internet small computer system interface protocol. The calculating module calculates identification information of the first data. The determining module determines whether a second data having the identification information is already stored in the server. The generating module generates and stores a pointer pointing to the second data and neglects the first data when the server already stores the second data having the identification information.

According to an embodiment of the invention, the first data is a part of data of a transmitted file.

According to an embodiment of the invention, when a data size of the first data meets a predetermined data size, the calculating module calculates the identification information of the first data.

According to an embodiment of the invention, the modules further include a recording module for storing the first data and recording the identification information of the first data when the second data is not stored in the server.

According to an embodiment of the invention, the calculating module calculates a hash value of the first data as the identification information of the first data.

Based on the above, the method provided in the embodiments of the invention is capable of determining whether the second data identical to the first data is already stored in the server when the server receives the first data through the Internet small computer system interface protocol, so as to determine whether to store the first data or only store the pointer pointing to the second data.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating a server according to an embodiment of the invention.

FIG. 2 is a flowchart illustrating a network storage deduplicating method according to an embodiment of the invention.

FIG. 3 is a schematic view illustrating an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

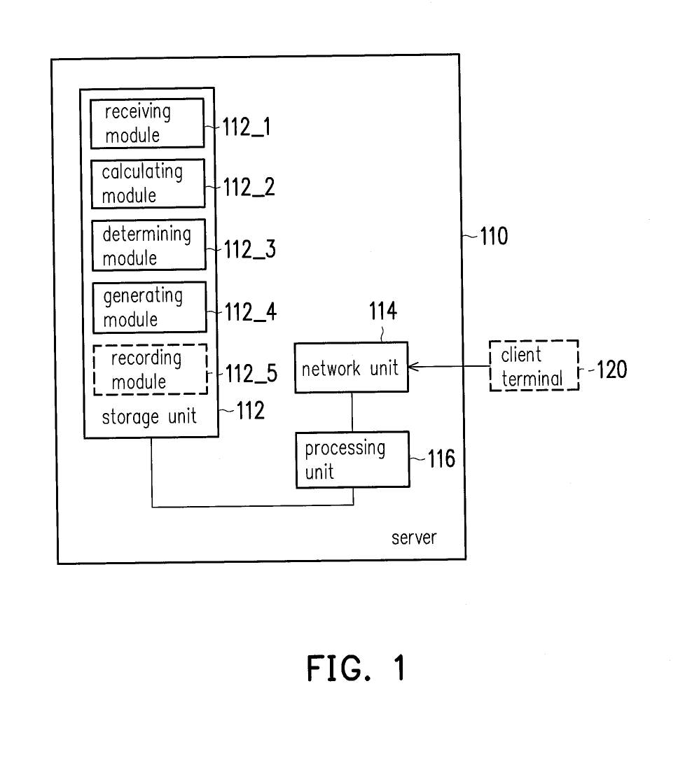

FIG. 1 is a schematic view illustrating a server according to an embodiment of the invention. In this embodiment, a server 110 is, for example, a cloud server, a network storage space, or other servers that allow remote file storage from a client terminal. The server 110 includes a storage unit 112, a network unit 114, and a processing unit 116. The storage unit 112 is, for example, a random access memory (RAM), a read-only memory (ROM), a flash memory, a hard disk of any type, or any other similar devices or a combination thereof, for example, capable of recording a plurality of programming codes or modules. The type of the storage unit 112 is not limited in the invention.

The network unit 114 is a communication unit capable of receiving data from another network device or transmitting data to a communication unit of another network device based on any network protocol. However, the embodiments of the invention are not limited thereto.

The processing unit 116 is coupled to the storage unit 112 and the network unit 114. The processing unit 116 may be a general purpose processor, a specific purpose processor, a conventional processor, a digital signal processor, a plurality of microprocessors, one or more microprocessors combined with a digital signal processing core, a controller, a microcontroller, an application specific integrated circuit (ASIC), a field programmable gate array (FPGA), integrated circuits, state machines, advanced RISC machine (ARM) processors of any kind and similar devices.

In an embodiment, a client terminal 120 may mount an iSCSI target on the server 110 through an Internet small computer system interface (iSCSI) protocol. In this way, the client terminal 120 (or an iSCSI initiator) may use the server 110 as a local hard disk. When the client terminal 120 stores a file in the local disk (i.e., the server 110), the client terminal 120 sends data associated with the file to the server 110.

At this time, the processing unit 116 may access a receiving module 112_1, a calculating module 112_2, a determining module 112_3, and a generating module 112_4 in the storage unit 112 to execute a network storage deduplicating method according to the invention to improve a usage efficiency of a storage space of the server 110.

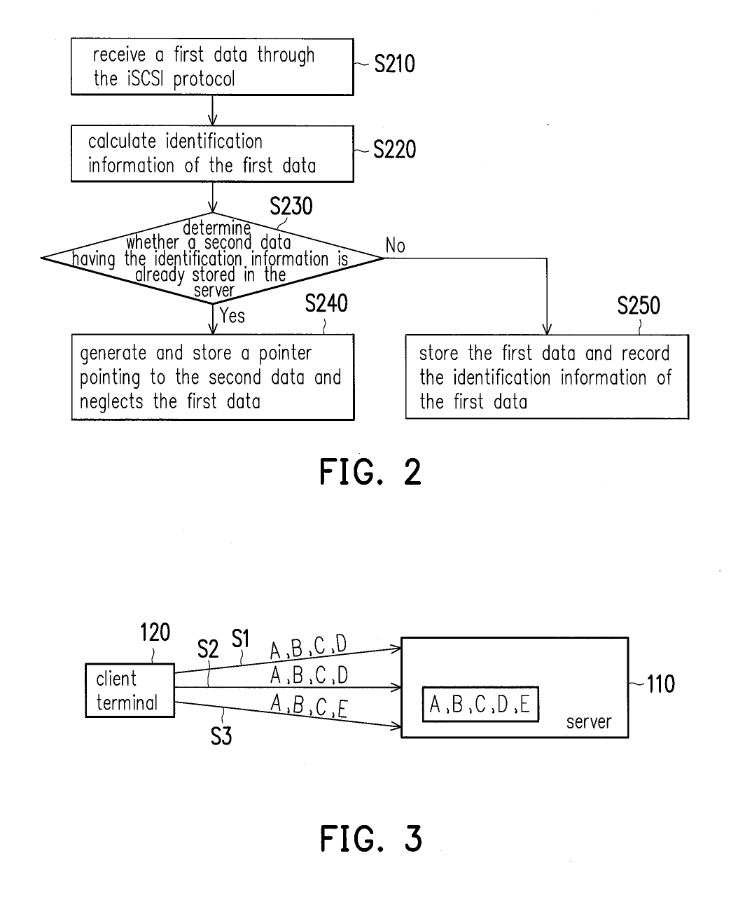

FIG. 2 is a flowchart illustrating a network storage deduplicating method according to an embodiment of the invention. The method provided by this embodiment may be executed by the server 110 shown in FIG. 1. In the following, details concerning steps of FIG. 2 are described with reference to the elements shown in FIG. 1.

At step S210, the receiving module 112_1 receives a first data through the iSCSI protocol. In an embodiment, the first data is a part of data of a transmitted file, for example. Specifically, the transmitted file is a file that the client terminal 120 intends to store in the server 110 and the first data is a part of the data of this file, for example.

Then, at step S220, the calculating module 112 calculates identification information of the first data. Specifically, the calculating module 112_2 calculates a hash value of the first data as the identification information of the first data. However, the embodiments of the invention are not limited thereto. For example, the calculating module 112_2 may also use other algorithms to calculate unique identification information corresponding to the first data.

In other embodiments, the calculating module 112_1 may calculate the identification information of the first data when a data size of the first data meets a predetermined data size. In other words, when the calculating module 112_2 receives data from the client terminal, the calculating module 112_2 does not immediately calculates identification information corresponding to the data, but waits until the received data accumulates and reaches the predetermined data size to calculate the identification information corresponding to the data. For example, if the predetermined data size is 64 KB, then the calculating module 112_2 may calculate the identification information (e.g., hash value) of the first data when the data size of the first data is equal to 64 KB. It should be noted that the predetermined data size of 64 KB described herein only serves as an example, instead of serving to limit possible embodiments of invention. The designer may determine the desired predetermined data size based on the design requirement.

At step S230, the determining module 112_3 determines whether a second data having the identification information is already stored in the server 110. If the second data of the identification information is already stored in the server 110, the process proceeds to step S240. If not, the process proceeds to step S250.

At step S240, the generating module 112_4 generates and stores a pointer pointing to the second data and neglects the first data. Specifically, since a function (e.g., a one-way hash function) for generating the hash value is generally a one-to-one function, when the hash value corresponding to the first data is the same as a hash value of the second data, it is indicated that the first data and the second data are the same data. In other words, when the determining module 112_{—} 3 finds that there is the second data the same as the first data in the server 110, the generating module 112_3 may neglect (i.e., not store) the first data and only store the pointer pointing to the second data. In this way, it is not necessary for the server 110 to consume additional space to repeatedly store the first data that is substantially the same as the second data (i.e., deduplication), thereby significantly improving the usage efficiency of the storage space of the server 110.

From another perspective, when the server 110 is configured for the user to back up data, the storage space may be wasted if the sever is not designed with an appropriate data storage mechanism, as the data are highly repetitive. With the method provided in the embodiment of the invention, the server 110 is allowed to automatically adjust the repeated data stored by the user to store only one copy of the repeated data. Therefore, redundant data may be eliminated and a rate that that the data increases may be preferably controlled and reduced. In other words, the method provided in the embodiment of the invention allows the server 110 to store more backup data and filed data in the limited storage space.

In other embodiments, the storage unit 112 of the sever 110 may further include a recording module 112_5. Referring to FIG. 2 again, at Step S250, when the second data the same as the first data is not stored in the server 110, the recording module 112_5 may store the first data and record the identification information of the first data.

In this way, when the server 110 subsequently receives a third data having identification information (e.g., hash value) the same as that of the first data, the generating module 112_4 may neglect (i.e., not store) the third data but only generate a pointer pointing to the first data.

FIG. 3 is a schematic view illustrating an embodiment of the invention. In this embodiment, it is assumed that the client terminal 120 stores data strings S1 to S3 in the server 110 at one or more time points, while the data string S1 includes data A, B, C, and D, the data string S2 includes data A, B, C, and D, and the data string S3 includes data A, B, C, and E. By implementing the method provided in the invention in the server 110, the server 110 does not store repeated data in the data strings S1 to S3, but only stores the effective data A, B, C, D, and E. Thus, the storage space in the server 110 may be used effectively.

In view of the foregoing, the method provided in the embodiments of the invention is capable of determining whether the second data the same as the first data is already stored in the server when the server receives the first data through the iSCSI protocol, so as to determine whether to store the first data or only store the pointer pointing to the second data. In this way, it is not necessary for the server to consume additional space to repeatedly store the first data that is substantially the same as the second data (i.e., deduplication), thereby significantly improving the usage efficiency of the storage space of the server.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A network storage deduplicating method, adapted for a server, comprising:
receiving a first data through an Internet small computer system interface protocol;
calculating identification information of the first data;
determining whether a second data having the identification information is already stored in the server; and
if the second data having the identification is already stored in the server, generating and storing a pointer pointing to the second data and neglecting the first data.

2. The method as claimed in claim 1, wherein the first data is a part of data of a transmitted file.

3. The method as claimed in claim 2, wherein the step of calculating the identification information of the first data comprises:
when a data size of the first data meets a predetermined data size, calculating the identification information of the first data.

4. The method as claimed in claim 1, wherein when second data is not stored in the server, the method further comprises:
storing the first data and recording the identification information of the first data.

5. The method as claimed in claim 4, wherein the step of calculating the identification information of the first data comprises:
calculating a hash value of the first data as the identification information of the first data.

6. A server, comprising:
a storage unit, storing a plurality of modules;
a communication unit;
a processing unit, coupled to the storage unit and the communication unit and accessing and executing the modules, wherein the modules comprise:
a receiving module, controlling the communication unit to receive a first data through an Internet small computer system interface protocol;
a calculating module, calculating identification information of the first data;
a determining module, determining whether a second data having the identification information is already stored in the server; and
a generating module, generating and storing a pointer pointing to the second data and neglecting the first data when the server already stores the second data having the identification information.

7. The server as claimed in claim 6, wherein the first data is a part of data of a transmitted file.

8. The server as claimed in claim 7, wherein when a data size of the first data meets a predetermined data size, the calculating module calculates the identification information of the first data.

9. The server as claimed in claim 6, wherein the modules further comprise a recording module for storing the first data and recording the identification information of the first data when the second data is not stored in the server.

10. The server as claimed in claim 9, wherein the calculating module calculates a hash value of the first data as the identification information of the first data.
